(19) United States
(12) Patent Application Publication
(10) Pub. No.: US 2025/0370189 A1
(43) Pub. Date: Dec. 4, 2025

(54) Method and device for finite impulse response optical filtering and corresponding items of optical equipment

(71) Applicant: ORANGE, Issy-les-Moulineaux (FR)

(72) Inventors: Gael Simon, Châtillon (FR); Philippe Chanclou, Châtillon (FR); Jeremy Potet, Châtillon (FR); Fabienne Saliou, Châtillon (FR)

(21) Appl. No.: 18/875,224

(22) PCT Filed: Jun. 26, 2023
(86) PCT No.: PCT/EP2023/067226

§ 371 Date: Dec. 16, 2024

(30) Foreign Application Priority Data
Jun. 27, 2022 (FR) FR2206391

(51) Int. Cl. G02B 6/28; H04B 10/2507

(52) U.S. Cl. CPC G02B 6/2861; H04B 10/2507

(57) ABSTRACT

A finite impulse response optical filtering device. The device includes: at least one 1 to N optical coupler), configured to separate an incident optical signal into N optical signals transmitted at the input of N optical channels, respectively; N optical channels each comprising an optical waveguide capable of propagating an optical signal transmitted on the channel, a module configured to attenuate or amplify the optical signal propagated by the optical waveguide and a delay module capable of delaying a propagation of the optical signal by the optical waveguide; and P photodiodes arranged at the output of an N/P set of N optical channels, respectively, and configured so that optical signals delivered by the optical waveguides of the set of N/P optical channels are incident on a detection surface of the photodiode arranged at the output of the set of N/P optical channels.

### TECHNICAL FIELD

The field of the invention is that of telecommunications by optical fibres, for example in the context of passive optical networks (PON) enabling high transmission rates. More specifically, the invention relates to a finite impulse response optical filter suitable for use in such a network, or more generally in the field of optical telecommunications.

### PRIOR ART

The finite impulse response filter, known as FIR, is commonly used in signal processing for signal equalisation, i.e. to compensate for the distortions introduced in the frequency domain by the various elements of the signal transmission chain. In particular, it is increasingly used in optical access networks. A FIR filter is a filter whose impulse response is of finite duration.

The general principle of such a finite impulse response filter is illustrated in [FIG. 1].

In the case of an analogue FIR filter, the input signal x[n] is separated into several channels, to each of which a delay z⁻¹ is applied, together with an attenuation or amplification whose amplitude is given by a coefficient bᵢ, which corresponds to a coefficient of the filter transfer function. The different signals, which experience fixed z⁻¹ delays and different amplifications/attenuations of coefficient bᵢ, are then recombined at each stage of the filter. The signal y[n] obtained at the output of such a FIR filter is the result of the weighted sum of the different signals passing through the different channels of the filter, and is expressed as:

$$y [ n ] = {b}_{0} \cdot x [ n ] + {b}_{1} \cdot x [ n - 1 ] + {b}_{2} \cdot x [ n - 2 ] + … + {b}_{N} \cdot x [ n - N ]$$

$$Let$$

$$y [ n ] = {\sum }_{i = 0}^{N} {b}_{i} \cdot x [ n - i ]$$

Where N−1 refers to the order of the filter, and where the coefficients bᵢ refer to the coefficients of the filter transfer function. The above equation expresses a discrete convolution between the input signal x[n] and a function represented by the values bᵢ, which describe the impulse response of the filter.

The filter thus performs an equalisation on the input signal x[n] by recombining with this same signal different delayed and amplified or attenuated versions of itself.

This type of filter is already widely produced and used in the field of electricity to equalise electrical signals, both in the world of electronics and in the world of photonics, particularly for telecommunications.

Work has been reported on the production of such FIR filters which would equalise signals, not in the field of electricity, but in the field of optics.

Indeed, for many years now, there has been a great deal of interest in the possibility of producing all-optical FIR filters in order to make use of the wide bandwidth of optics. An all-optical filtering method could significantly improve signal processing performance when the signal to be processed is at high speed.

Thus, work has been carried out in free space, using the polarisation properties of light, as described in the article by Y. Zhou, G. Zeng, F. Yu, and H. S. Kwok, “Study on optical finite impulse response filter,” Opt. Eng., vol. 42, no. 8, p. 2318, 2003. However, one disadvantage of the latter is that optics in free-space does not lend itself to the field of optical telecommunications, mainly because of its footprint, but also because of the difficulty of creating and maintaining complicated optical alignments.

Other work has been carried out in integrated photonics on silicon on insulator, using the properties of photonic crystals, presented for example in the article by M. Gay et al, “Silicon-on-Insulator RF Filter Based on Photonic Crystal Functions for Channel Equalization,” IEEE Photonics Technology Letters, vol. 28, no. 23, pp. 2756-2759 December 2016.

The schematic diagram of such an optical FIR filter is illustrated in [FIG. 2], in the simple example of a two-stage FIR filter (or taps). The input optical signal 10 passes through an optical coupler 11, which separates it: on a first channel 12, the optical signal is not delayed, but is attenuated or amplified by means of a variable optical attenuator (VOA) 122 or an optical amplifier; on a second channel 13, the optical signal is subject to a delay T 131 and to an attenuation/amplification 132. These two signals are then recombined, before being detected by a photodiode 14, which delivers an electrical signal at its output. In principle, such an optical FIR filter corresponds to a Mach-Zehnder interferometer.

However, the production of a FIR filter in guided optics poses a problem in terms of detecting the signal at the output. In fact, when several optical waves that do not travel the same path are combined, they interfere, and this interference phenomenon can go so far as to extinguish the output signal, in the case of destructive interference.

This phenomenon is illustrated by the schematic representation in [FIG. 3], which is not to scale. The optical intensity detected by photodiode 14 can be expressed as:

$$I ( t ) = {I}_{1} + {I}_{2} + 2 ( Δ Φ ) \sqrt{{I}_{1} {I}_{2}}$$

Where I₁ refers to the intensity of the signal passing through the first channel 12, I₂ refers to the intensity of the signal passing through the second channel 13, and where the complementary term of the equation corresponds to the interference term of the two signals passing through the two channels, which is graphically transcribed by the pulses represented on the upper part of the graph in [FIG. 3], within the envelopes of the two optical signals.

For optimum operation of an optical FIR filter, it is necessary to detect only the amplitude of the two signals, i.e.:

I(t)=I₁+I₂, which corresponds to the lower part of the graph in [FIG. 3].

It is therefore necessary to implement a solution for detecting the optical beams at the output of the filter which would not enable the optical beams to interfere with each other. Previous work has shown that this effect can be cancelled out by using multimode interferometers. However, such multimode interferometers are expensive.

To date, there is no all-optical FIR filter enabling direct detection of the signal at the output without using any component preventing interference between the recombined signals from the different channels.

There is therefore a need for a FIR optical filter architecture that does not have these various disadvantages of the prior art. In particular, there is a need for such an optic FIR filter architecture on optical fibre coupled with a detection method enabling to detect the signal at the output of the filter on a photodiode, without using any component cancelling out the interference effects between the waves at the output.

### SUMMARY OF THE INVENTION

The invention responds to this need by proposing a finite impulse response optical filtering device comprising:
at least one 1 to N optical coupler, where N is a natural integer greater than or equal to 2, configured to separate an incident optical signal into N optical signals transmitted respectively at the input of N optical channels,
N optical channels each comprising an optical waveguide capable of propagating an optical signal transmitted on said channels, a module configured to attenuate or amplify said optical signal propagated by said optical waveguide and a delay module capable of delaying propagation of said optical signal by said optical waveguide,
P photodiodes, where P is a natural integer greater than or equal to 1, respectively arranged at the output of a set of N/P of said N optical channels and configured so that optical signals delivered by said optical waveguides of said set of N/P optical channels are incident on a detection surface of said photodiode arranged at the output of said set of N/P optical channels.

Thus, the invention is based on a completely new and inventive approach to an all-optical FIR filter architecture. Unlike solutions in the prior art, according to which the optical signals from the various filter channels were recombined in the same optical waveguide, arranged at the output of the filter, before the projection of the resulting optical beam onto a photodiode, the claimed architecture does not recombine the optical signals of the N optical channels before the projection onto the photodiode(s) arranged at the output of the device. Thus, N spatially separated optical beams are projected, at the output of N optical waveguides, onto the detection surface of P photodiodes. This makes it possible to avoid the interference phenomenon that could result from the recombination of the N optical signals upstream of their detection by the photodiode.

The module configured to attenuate or amplify the optical signal propagating on each of the channels is for example a variable optical attenuator (VOA) or an optical amplifier, or more generally any type of optical or mechanical device for attenuating or amplifying light.

According to one embodiment, P=1, and the device comprises a photodiode arranged at the output of the N optical channels and configured so that N optical signals delivered by the optical waveguides are incident on a detection surface of the photodiode.

This embodiment corresponds to the simplest case, in which all the optical beams from the different filter channels are projected onto the same photodiode. This embodiment has the advantage of being the least expensive.

In other implementations, there can be several photodiodes, for example two photodiodes each receiving on their surface half of the optical beams generated at the output of the N channels of the filter, or three photodiodes each receiving on their surface a third of the optical beams generated at the output of the N channels of the filter. Note that increasing the number of photodiodes increases the cost of the device. However, when the number N of optical channels is high, it may be necessary to provide for several photodiodes, to ensure spatial separation of the incident optical beams on the detection surface of the photodiode.

In an extreme case, it can be decided to place a photodiode at the output of each of the channels, i.e. to provide for N photodiodes, and to proceed to the recombination of the signals in the electrical domain.

According to one characteristic, the optical waveguides are optical fibres. Thus, the claimed optical FIR filter can be produced on an optical fibre with a photodiode having a sufficiently large detection surface with respect to the minimum spacing constraints between the two fibre cores.

According to another characteristic, the optical waveguides are made in integrated photonics.

Integrated photonics (on silicon, for example) improve the stability and precision of the device.

According to one aspect, the delay module of one of said N optical channels belongs to the group comprising:
an optical loop of length L; imposing a delay t; on the optical signal propagated along said optical channel;
an optical ring resonator configured to provide an adjustable optical delay line.

Such an optical ring resonator is for example described in the article by G. Rostami and A. Rostami, “Tunable optical delay line using two port ring resonator,” 2006 Asia-Pacific Microwave Conference, December 2006, pp. 1308-1312.

It should be noted that, in one embodiment, the signal propagating on one of the N optical channels is not subject to any delay, so that the delay module imposes on it a delay tᵢ=0.

More generally, the delay modules are configured to introduce different delays tᵢ on each of the N optical channels. In one embodiment, the taps are temporally spaced, by means of delay lines, by a multiple of T or T/2, where T refers to the symbol time.

According to another aspect, the optical waveguides and the photodiodes are configured so that beams of the incident optical signals on the detection surface of one of the photodiodes are spatially separated.

Indeed, if it is possible to detect the different optical beams spatially separated on the surface of the photodiode, avoiding the use of an optical coupler which would cause the signals to interfere, then only the amplitudes of the different beams are detected by the photodiode, and interference is avoided. This makes it possible to implement such a device in a fibre architecture without having to use original optical components. The optimal case is when the N optical beams are completely separated spatially. Such a spatial decorrelation of the optical signals is indeed able to detect only their amplitudes, or the envelopes of the signals, rather than the beats, or oscillations, corresponding to the interference terms between the signals.

This configuration is obtained by achieving an optimal compromise between the size of the detection surface of the photodiode(s) and the spacing between the different optical waveguides of each of the channels at the output of the filter. This compromise depends, of course, on the technology used and on the components chosen to produce the optical filtering device claimed.

According to yet another aspect, the optical waveguides and the photodiodes are configured so that a spatial overlap of the beams of the incident optical signals on the detection surface of one of the photodiodes is less than a predetermined overlap threshold. This configuration corresponds to an intermediate case, which occurs when the beams partially overlap on the detection surface of the photodiode. An overlap threshold is set, below which the claimed device can continue to operate effectively. It should be noted that when the beam overlap is significant or total (i.e. greater than the determined overlap threshold), the interference between the beams becomes dominant and the FIR filter becomes ineffective.

The invention also relates to an optical line terminal (OLT) of an optical communication network comprising an optical filtering device as previously described.

The invention further relates to an optical network unit (ONU) of an optical communication network comprising an optical filtering device as previously described.

The invention finally relates to a method for finite impulse response optical filtering, comprising:
a separation of an incident optical signal into N optical signals transmitted respectively at the input of N optical channels each comprising an optical waveguide, where N is a natural integer greater than or equal to 2,
on each of the N optical channels, an attenuation or amplification of an optical signal propagated by the optical waveguide and an application of a propagation delay to the optical signal,
for each set of N/P optical channels, where P is a natural integer greater than or equal to 1, a projection of the optical signals delivered by the optical waveguides of said set of N/P optical channels onto a detection surface of a photodiode arranged at the output of the set of N/P optical channels, so that a spatial overlap of the beams of the optical signals projected onto the detection surface is below a determined overlap threshold.

The aforementioned method for finite impulse response optical filtering, optical line terminal (OLT) and optical network unit (ONU) have at least the same advantages as those provided by the optical filtering device according to the present invention.

### PRESENTATION OF THE FIGURES

Other purposes, features and advantages of the invention will become more apparent upon reading the following description, hereby given to serve as an illustrative and non-restrictive example, in relation to the figures, among which:

FIG. 1 shows the general principle of a finite impulse response filter of the prior art;

FIG. 2 illustrates the principle of a finite impulse response optical filter in integrated photonics according to the prior art;

FIG. 3 graphically describes the interference phenomenon that occurs with an optical filter as shown in FIG. 2;

FIG. 4 shows the architecture of an optical device for finite impulse response filtering according to one embodiment of the invention, in the simple example of a two-stage filter;

FIG. 5A

FIG. 5B

FIG. 5C: these three figures schematically show the different configurations of optical signal projections on the detection surface of the photodiode of FIG. 4;

FIG. 6 shows the general architecture of a device for finite impulse response optical filtering in an embodiment with N optical channels and P photodiodes.

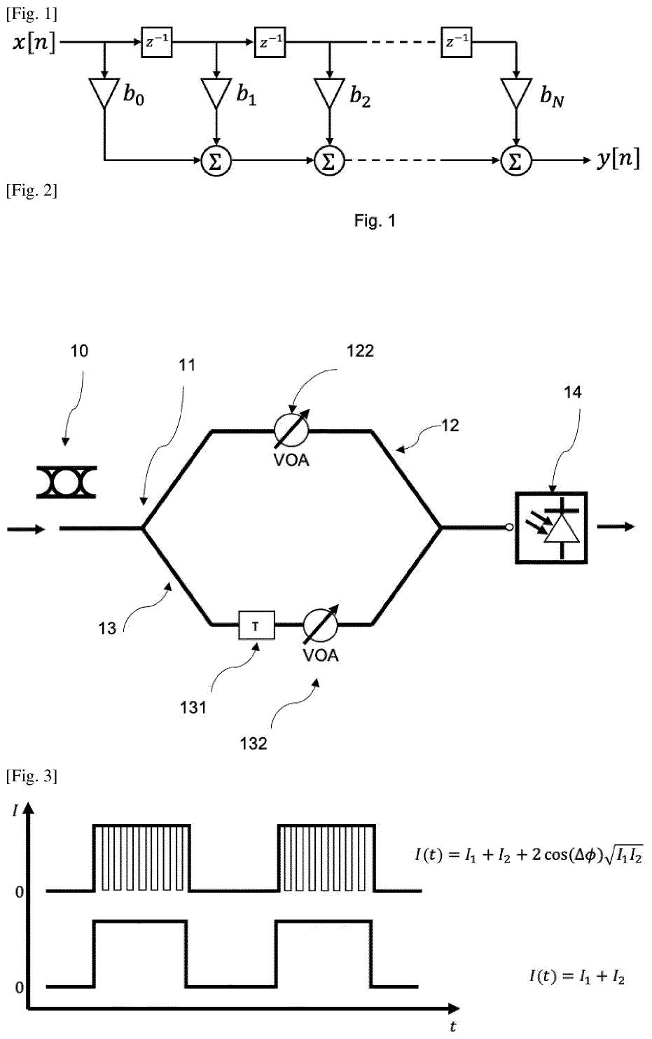

### DETAILED DESCRIPTION OF EMBODIMENTS OF THE INVENTION

The general principle of the invention is based on a finite impulse response optical filter device architecture coupled with a detection method enabling the optical signal at the output of the filter to be detected on a photodiode without using any component cancelling out the interference effects between the optical waves at the output.

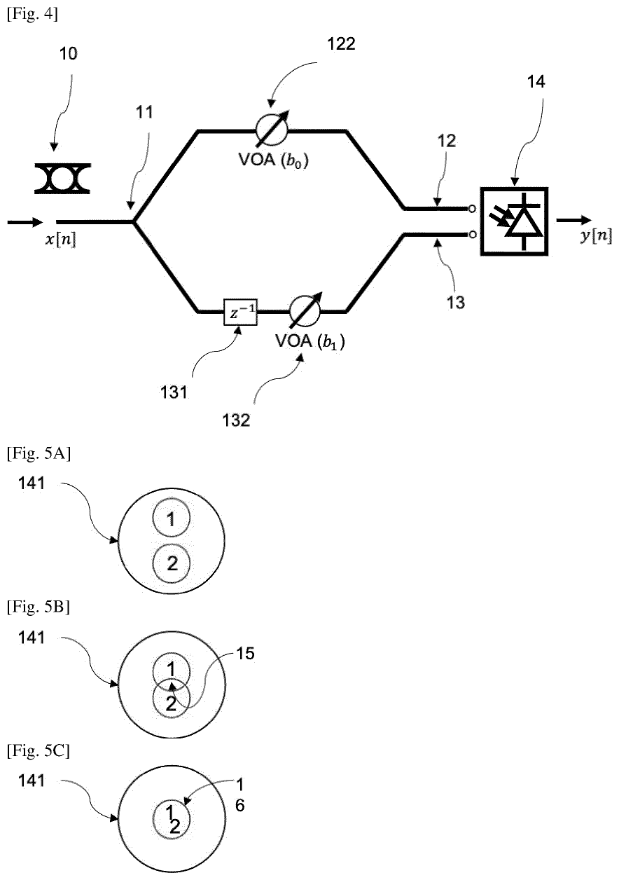

This general principle is illustrated, in a simple embodiment wherein the filter comprises N=2 optical channels and P=1 photodiode, by the architecture of FIG. 4. Those skilled in the art will easily extend this information to other N and P values.

For example, FIG. 4 shows the functional diagram of a 1st order optical FIR filter, i.e. with only two stages (“taps”), or N=2 optical channels.

The incident optical signal x[n] 10 is split into two by an optical coupler 11. On the upper arm, the signal encounters an element 122 that makes it possible to attenuate or amplify the signal, for example a variable optical attenuator or VOA or an optical amplifier (a semiconductor optical amplifier, for example), used to apply a multiplication coefficient b₀ to the optical signal travelling in the optical waveguide 12. On the lower arm, the signal encounters a delay 131 with respect to the optical path of the arm and an attenuation/amplification element 132. The delay element 131 is produced for example by means of a delay loop which lengthens the optical signal path. The attenuation/amplification element 132 is for example a variable optical attenuator or VOA or an optical amplifier, used to apply a multiplication coefficient b₁ to the optical signal travelling in the optical waveguide 13. The optical beams travelling in the optical waveguides 12 and 13 are then projected, at the output of the filter, onto the surface of a photodiode 14. The signals from the two arms 12 and 13 of the filter are thus detected on the surface of photodiode 14, which delivers at the output an electrical signal y[n]. These signals are not recombined in the same optical waveguide before projection onto the surface of the photodiode 14.

FIGS. 5A to 5C show the different illumination configurations of the detection surface 141 of the photodiode 14.

FIG. 5A shows the optimal operating case for the FIR optical filter shown in FIG. 4. In this configuration, the incident optical beams from the optical waveguides referenced 12 and 13 are projected into two completely separate zones, referenced 1 and 2. In this configuration, the detection surface 141 is large enough to ensure that there is no overlap between the projections of the two beams; similarly, the orientation and spacing of the two optical waveguides 12, 13 ensure that there is no overlap on the surface of the photodiode 14.

FIG. 5B shows an acceptable operating case for the FIR optical filter shown in FIG. 4. In this configuration, the incident optical beams from the optical waveguides referenced 12 and 13 are projected into two completely separate zones that partially overlap, referenced 1 and 2. However, this partial overlap 15 is small enough to allow detection of the intensities I₁ and I₂ of the optical signals projected by the optical waveguides 12 and 13 respectively.

On the other hand, FIG. 5C shows a configuration in which the projection of the optical beams from the optical waveguides 12 and 13 occurs on the same zone 16: there is total overlap. When the beam overlap is significant or total, the interference between the beams becomes dominant and the FIR filter becomes ineffective.

The filter shown in FIG. 4 can be produced in fibre optics with a photodiode having a sufficiently large detection surface for operation in the optimal case shown in FIG. 5A. Integrated photonics (on silicon, for example) can also be used, to improve the stability and precision of the device.

Such an all-optical FIR filter makes it possible to perform all-optical signal processing and equalisation functions, without having to convert the optical signal to the electrical world. In particular, it makes it possible to implement all-optical equalisation to compensate for distortion and various transmission problems in optical telecommunications systems. It can advantageously be integrated into any optical network equipment in which signal equalisation is useful, such as line termination equipment of the OLT type or an optical network unit of the ONU type.

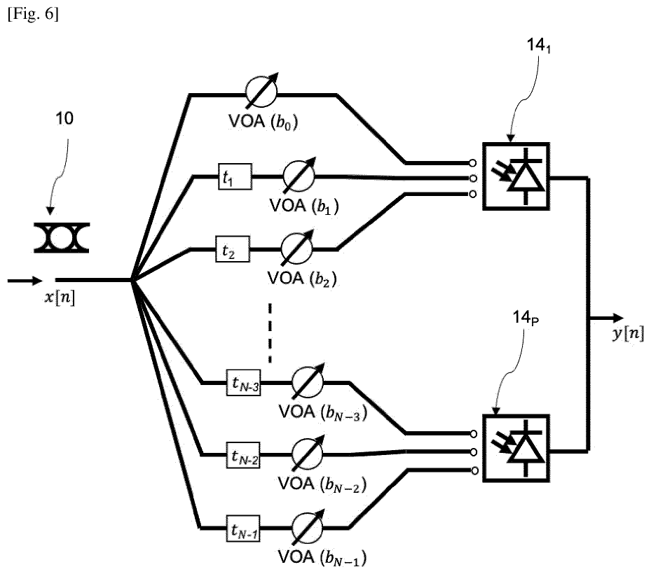

FIG. 6 shows the more general architecture of a device for finite impulse response optical filtering of order N−1 in an embodiment with N optical channels and P photodiodes.

The incident optical signal x[n] 10 is split into N by an optical coupler. On each of the N arms, the signal encounters an element of the VOA type or optical amplifier to attenuate or amplify the signal, and a delay (possibly zero on channel i=0) relative to the optical path of the arm. The delay element of the optical channel, or arm, of index i is used to apply a delay tᵢ to the optical signal. In one embodiment, the delays of the different channels follow each other. For example, by referring to the symbol time (i.e. the inverse of the bit rate) by T, we can construct a device wherein the taps are spaced by T: the delay applied to channel 1 is then T, the delay applied to channel 2 is 2T, the delay applied to channel 3 is 3T, and the delay applied to channel i is therefore i*T, etc. The attenuation/amplification element of the optical channel, or arm, of index i, makes it possible to apply a multiplication coefficient bᵢ to the optical signal travelling in channel i.

In this example, it is chosen by way of illustration, to gather the optical channels by groups of three: thus, the optical beams travelling in the optical waveguides of index 0, 1 and 2 are projected, at the output of the filter, onto the surface of a photodiode 14₁; the optical beams travelling in the optical waveguides of index 3, 4 and 5 (not shown) are projected, at the output of the filter, onto the surface of a photodiode 14₂, and so on, up to the optical beams travelling in the optical waveguides of index N−3, N−2 and N−1, which are projected, at the output of the filter, onto the surface of a photodiode 14P. The output signals from photodiodes 14₁ to 14ₚ are added together to reconstitute the resulting electrical signal y[n].

The choice of the number N of filter stages and the number P of photodiodes depends on various criteria, on the precision required for the FIR optical filter and on the application considered.

Indeed, the speed of charge carriers, and therefore the bandwidth of a photodiode, is directly related to its active surface. Typically, for a bandwidth of 20 GHz, the diameter D

of the active surface of a photodiode is in the order of D≥10 μm. This order of magnitude is taken from the specifications of component manufacturers. The larger the active surface of the photodiode, the slower the photodiode. It is therefore necessary to aim for photodiode surfaces that are small enough for high-speed applications. However, it is understood that the larger the surface area of the photodiode, the greater the number of optical beams that can be projected onto this surface without overlap (FIG. 5A), or with acceptable overlap (FIG. 5B).

In the case of an implementation of the FIR optical filtering device in the form of a fibre component, the characteristics of single-mode optical cables and fibres, described for example in ITU (International Telecommunications Union) standard G. 652 (11/16 approved on 13 Nov. 2016), should also be taken into account. In particular, the standard stipulates that the core diameter of SSMF 28 single-mode fibre (used in networks) is D=9 μm; the minimal spacing between two fibre cores is e≥30 μm. This minimal spacing determines the proximity of the different output optical arms of the optical FIR filter and hence, consequently, the number of distinct optical beams that can be projected from these different optical arms onto the active surface of the same photodiode.

In the case of an implementation of the FIR optical filtering device in the form of an integrated photonic component, the design constraints of the optical waveguides must also be taken into account. The work by Y. Huang, Q. Zhao, F. Kamyab, A. Rostami, F. Capolino, and O. Boyraz in “Sub-micron Silicon nitride waveguide fabrication using conventional optical lithography,” Opt. Express, vol. 23, no. 5, p. 6780 March 2015, report, for example, a state of the art order of magnitude of the typical size of an optical waveguide d≤1 μm. It should be noted that this value is indicative, as it is highly dependent on technologies, wavelengths, the desired wave guidance. Similarly, the minimal spacing between two waveguides is in the order of e≥3-4 μm.

All these values are indicative and vary greatly with the technologies, manufacturing methods, materials and parameters of the final photonic device (guidance, wavelength, etc.). They must nevertheless be taken into account in order to satisfy the compromise necessary for the operation of the claimed optical FIR filtering device, namely the choice of the size of the active surface of the photodiode on the one hand, and the choice of the number of distinct optical beams projected by the output waveguides of the device onto this active surface on the other hand, in order to ensure that the optical beams are spatially separated at the surface of the photodiode, or overlap sufficiently little for the operation of the optical FIR filter to remain acceptable in terms of performance.

1. A finite impulse response optical filtering device, comprising:
at least one 1 to N optical coupler, where N is a natural integer greater than or equal to 2, configured to separate an incident optical signal into N optical signals transmitted respectively at an input of N optical channels,
N optical channels each comprising an optical waveguide capable of propagating an optical signal transmitted on said channels, a module an attenuator or an amplifier configured to attenuate or amplify said optical signal propagated by said optical waveguide and a delay capable of delaying propagation of said optical signal by said optical waveguide, and
P photodiodes, where P is a natural integer greater than or equal to 1, respectively arranged at an output of a set of N/P optical channels among said N optical channels and configured so that optical signals delivered by said optical waveguides of said set of N/P optical channels are incident on a detection surface of said photodiode arranged at the output of said set of N/P optical channels.

2. The finite optical Optical-filtering device according to claim 1, wherein P=1, and said device comprises a photodiode arranged at the output of said N optical channels and configured so that N optical signals delivered by said N optical waveguides are incident on a detection surface of said photodiode.

3. The finite optical filtering device according to claim 1, wherein said optical waveguides are optical fibres.

4. The finite optical filtering device according to claim 1, wherein said optical waveguides are made of integrated photonics.

5. The finite optical filtering device according to claim 1, wherein said delay of at least one of said N optical channels belongs to the group consisting of:
an optical loop of length Lᵢ imposing a delay tᵢ on the optical signal propagated along said optical channel;
an optical ring resonator configured to provide an adjustable optical delay line.

6. The finite optical filtering device according to claim 5, wherein said delays of said N optical channels are configured to introduce different delays tᵢ on each of said N optical channels.

7. The finite optical filtering device according to claim 1, wherein said optical waveguides and said photodiodes are configured so that beams of said incident optical signals on said detection surface of one of said photodiodes are spatially separated.

8. The finite optical filtering device according to claim 1, wherein said optical waveguides and said photodiodes are configured so that a spatial overlap of beams of said incident optical signals on said detection surface of at least one of said photodiodes is below a determined overlap threshold.

9. An optical line terminal of an optical communication network comprising the finite optical filtering device according to claim 1.

10. An optical network unit (ONU) of an optical communication network comprising the finite optical filtering device according to claim 1.

11. A method for finite impulse response optical filtering, comprising:
separating an incident optical signal into N optical signals transmitted respectively at an input of N optical channels each comprising an optical waveguide, where N is a natural integer greater than or equal to 2,
on each of said N optical channels, attenuating or amplifying an optical signal propagated by said optical waveguide and applying a propagation delay to said optical signal,
for each set of N/P optical channels among said N optical channels, where P is a natural integer greater than or equal to 1, projecting the optical signals delivered by said optical waveguides of said set of N/P optical channels onto a detection surface of a photodiode arranged at an output of said set of N/P optical channels, so that a spatial overlap of beams of said optical signals projected onto said detection surface is below a determined overlap threshold.
